(19) United States
(12) Patent Application Publication
(10) Pub. No.: US 2024/0425429 A1
(43) Pub. Date: Dec. 26, 2024

(54) DOMESTIC COMPOSTER

(71) Applicant: GREENZY, Ittre (BE)

(72) Inventors: Laetitia DUPRET, Woluwe-Saint-Lambert (BE); Adelaide BIEBUYCK, Ittre (BE); Fiona MILANO, Nivelles (BE); Sam DEBETENCOURT, Laneffe (BE); Lionel CONVENT, Lasne (BE); Brecht VANDEVENNE, Antwerpen (BE); Sander DE CLERCQ, Borgerhout (BE); Kaat KENIS, Wuustwezel (BE)

(73) Assignee: GREENZY, Ittre (BE)

(21) Appl. No.: 18/698,754

(22) PCT Filed: Oct. 5, 2022
(86) PCT No.: PCT/EP2022/077739

§ 371 Date: Apr. 4, 2024

(30) Foreign Application Priority Data
Oct. 7, 2021 (BE) BE2021/5781

(51) Int. Cl. C05F 17/979; C05F 17/907

(52) U.S. Cl. CPC C05F 17/979; C05F 17/907

(57) ABSTRACT

A domestic organic waste composter is provided. The composter can include an inlet for receiving organic waste; a grinder for grinding the organic waste; a tank surmounted by the grinder and arranged to contain the organic waste ground by the grinder; a mixer arranged in the tank and configured to mix the ground organic waste contained in the tank; an outlet arranged at the level of a bottom of the tank to recover a potting soil produced by composting the organic waste contained in the tank; and an aeration system configured to generate a circulation of air in the tank from the air inlet towards the air outlet via orifices. The aeration system can include an air inlet containing a fan; the orifices for circulating air in the tank; and an air outlet fluidly coupled to the orifices.

### TECHNICAL FIELD

This invention concerns a composter, and more particularly a domestic organic waste composter.

### BACKGROUND

The household waste management represents a real environmental challenge. Every day, tonnes of waste are dumped or incinerated around the world. To reduce the environmental impact of this waste, the composting of the organic household waste (e.g. kitchen waste, garden waste, etc.) is a well-known and effective solution. In fact, this type of household waste generally represents 50% of a European household bin.

From a domestic point of view, this solution is typically implemented in the form of piles of organic waste in a garden or outdoor bins in which the organic waste is placed.

It is clear that few private individuals are adopting this solution because, in Europe today, more than 80% of organic waste ends up being buried or incinerated, creating totally avoidable environmental pollution.

It is therefore necessary to provide a more attractive, simpler and more accessible solution for private individuals to compost organic waste.

### DISCLOSURE OF THE INVENTION

One object of the present invention is to provide a domestic organic waste composter that is both easier to use and more efficient than the composters known in the prior art.

To this end, the present invention proposes a domestic organic waste composter comprising:
an inlet for receiving organic waste;
a grinder for grinding the organic waste, coupled to a first actuator;
a tank surmounted by the grinder and arranged to contain the organic waste grinded by the grinder;
a mixer arranged in the tank to mix (and aerate) the grinded organic waste contained in the tank, coupled to a second actuator;
an outlet arranged at the level of the bottom of the tank to recover a potting soil produced by composting the organic waste contained in the tank.

The composter is also typically equipped with an aeration system comprising:
an air inlet containing a fan;
air circulation orifices in the tank, at the level of the bottom of the tank;
an air outlet, preferably coupled in a fluidic manner to the orifices;

This aeration system is then configured to generate a circulation of air in the tank, from the air inlet towards the air outlet, via the orifices.

The composter according to the invention is particularly easy to use. In particular, all you have to do is insert organic waste into the inlet, operate the grinder and/or the mixer as required (if they are not automated), and recover the potting soil obtained after a certain period of time. With the grinder surmounting the tank, the grinded organic waste simply falls into the tank by gravity, without any further technical input, and is then mixed and aerated by the mixer. The grinder and the mixer allow a rapid transformation of the organic waste into potting soil, making the composter much more efficient than the basic outdoor composting techniques known in the prior art. The potting soil can then be easily collected from the outlet and used in a variety of applications, for example to feed houseplants, so that the organic waste composted by the composter is put to good use.

In simple terms, the tank allows to contain the organic waste, without taking up too much space, in optimum conditions of hygiene and cleanliness, with the only access to the inside of the composter preferably being the inlet and the outlet. The composter can therefore be placed easily and without disturbance in a busy living area of a home, for example, by means of a wall suspension. In particular, it does not require access to a garden, so it is also suitable for flats. In particular, due to its “domestic” nature, the composter according to the invention is specifically adapted and/or sized to be placed in a living area of a home or of a community, for example, a kitchen.

The aeration system also plays an advantageous role: it allows to aerate the compost in the tank, speeding up the composting so that the potting soil can be created and recovered more quickly. In this way, the composter according the embodiments shown in FIGS. 1 to 10B below can transform the organic waste into potting soil in just about two months.

The fan allows an aspiration of air from outside the composter towards the inside of the tank. It can operate on the basis of a power supply, for example at a voltage of 12V and a current of 1 A, for example with a battery or by connection to the electrical network.

Preferably, the air inlet surmounted at least partially the tank. The fan is therefore preferably placed at the top of the tank, or higher than the tank. For example, it can be arranged at the level of a side wall of the tank, so as to surmount at least a portion of the tank. It can also surmount completely the tank and be held in place by an upper wall of the composter. The fact that it is at the top of the tank and that the air circulation orifices are at the bottom of the tank, at the level of the bottom of the tank, is very advantageous for ensuring an air circulation throughout the tank, from top to bottom. Very preferably, the air that enters the tank through the air inlet can only leave through the air outlet, via the orifices, so that the air circulation system ultimately guides the air circulation in the tank. The air circulating in the tank passes through all the grinded organic waste and the potting soil (which may be forming), or in other words, the compost, in the tank to supply it with oxygen in a controlled way, making composting more efficient.

It is also advantageous for the air circulation orifices to be located at the level of the bottom of the tank. The bottom of the tank is usually filled with mature compost in the form of potting soil. This allows air to pass through this potting soil, helping to oxygenate the potting soil and rid the air of odours. The potting soil acts as a natural filter. In this way, the potential odour nuisance is reduced when the air reaches the air outlet. This would not have been the case if the orifices were located higher up in the tank, where there is not necessarily any potting soil. It should also be noted that the words “at the level of the bottom of the tank” do not imply that the orifices are in the bottom of the tank, but that they are located in the immediate vicinity of the bottom of the tank, in the lower portion of the it.

Preferably, the air outlet comprises an air filter. The air filter helps to filter out any odours emanating from the tank that may not have been attenuated by the advantageous positioning of the orifices. It preferably comprises a box filled with activated carbon balls to filter the air passing through the box.

Thanks to these various components and their advantages, the composter according to the present invention makes the composting of the organic waste more attractive, more accessible and easier for private individuals.

In the context of this document, terms introducing generic devices such as “grinder”, “mixer”, (or hereafter “fan”) are to be interpreted generically, without any limitation to a particular structural design of the device. The terms “grinder”, “mixer” and “fan” should therefore be interpreted in the same way as “grinding means”, “mixing means” and “ventilation means”.

For the purposes of this document, the composter preferably extends along an “axle of the composter” directed from the outlet towards the inlet of the composter. The axle is preferably directed “from the bottom towards the top”. Preferably, the inlet is located higher than the grinder, which is located higher than the mixer, which is located higher than the outlet. The “bottom” of the tank is also logically at the bottom of the tank, as the person skilled in the art would legitimately understand. The axle is preferably directed parallel to and in the opposite direction to the force of gravity.

The term “surmount” (and its derivatives) used in this document also indicates, preferentially, an arrangement of one element of the composter above another (along said axle), i.e. higher than another, which corresponds to a customary use of this term, as the person skilled in the art would understand it.

Preferably, the “fluidic coupling” between the air circulation orifices and the air outlet consists of a line and/or a pipe and/or a particular path in the tank specifically leading a fluid, air in this case, from these orifices towards the air outlet. This type of fluidic coupling preferably channels the circulation of air between these orifices and the air outlet within the tank.

Although the description of the invention concerns a composter equipped with an aeration system, the person skilled in the art will directly understand without ambiguity that this (and these technical specifications) is preferred for a generic composter equipped with an inlet, a grinder, a tank, a mixer and an outlet as indicated in general above. In particular, the present document will be considered by the person skilled in the art as also disclosing such a generic composter in combination with each of the embodiments set out below.

The use in this document of the verb “to comprise”, its variants and their conjugations in no way precludes the presence of elements other than those mentioned. Similarly, the use in this document of the indefinite article “a”, “an”, or the definite article “the”, to introduce an element in no way excludes the presence of a plurality of these elements.

The terms “first”, “second”, etc. are used in this document exclusively to differentiate elements linguistically, without implying an order between them, or implying that these elements are structurally distinct. The specific case where the first and second actuators are at least partially the same technical element of the composter is perfectly conceivable within the framework of the invention as introduced below.

In a preferred embodiment of the invention, the first and second actuators are manual. This embodiment is also perfectly in keeping with the domestic nature of the composter. Given that the composter is dedicated to composting the household and organic waste of a handful of people, it's perfectly feasible to operate the grinder and the mixer manually, as only a small amount of waste needs to be composted. In particular, such embodiment would not be possible on large industrial composters. These actuators may, for example, take the form of cranks to be turned or manipulated by a user of the composter, with the aim of driving the grinder and/or the mixer by mechanical coupling (for example, via one or more mechanical axles).

The actuators are preferably exclusively manual. Advantageously, no electrical or electronic power supply is required to operate the grinder and the mixer, which contributes to making the composter more energy independent and environmentally friendly.

Alternatively, the first and/or second actuators can comprise motorisation means so that they can be both manual and motorised as required by the user. So an elderly person will be able to grind and mix their waste without having to develop manual strength, or with reduced manual strength, depending on whether or not motorised means are used. Such motorised means are known to a person skilled in the art. For example, an electric motor hidden in a crank base is one of the actuators. These motorised means can operate by battery or via a power supply from the network. A battery power or the absence of any means of motorising the actuators has the added advantage of allowing the composter to be placed anywhere in the home, without having to take into account the locations where an electricity supply is available.

According to a preferred embodiment, the composter comprises a set of one or more sensors from:
a temperature and/or humidity sensor for the air in the tank;
a temperature and/or humidity sensor for the grinded organic waste and/or for the potting soil contained in the tank;
a sensor for a selection of composting gases in the tank;

the sensors being configured to transmit data to a data processing logic unit.

The term “data processing logic unit” preferably comprises any computerised logic unit capable of processing data from the sensors, and therefore, for example, a computer, a smartphone, a computer network, or in general any programmable apparatus. The actual processing of the data of the sensors is preferably carried out using a computer program, for example via a smartphone application.

Advantageously, by transmitting their data, the sensors allow to monitor the compost in the tank, and in particular to check that it is at the right humidity and/or temperature, and/or that the same applies to the (ambient) air within the tank, as these parameters affect the speed and the quality of the composting. More generally, the sensors can be used to check that the composting is taking place in good conditions, and to take action if necessary via the grinder and/or the mixer, and/or any other technical element equipped to the composter, in order to re-establish such conditions. For example, gas emissions likely to cause odour nuisance can be anticipated. The sensors preferably comprise at least one sensor for the temperature and humidity of the air in the tank and one sensor for the humidity of the grinded organic waste and/or of the potting soil contained in the tank. They are preferably protected by a structure within the tank or in its immediate vicinity. They can be assembled in the same structure, or arranged in the tank according to the data they need to capture.

Preferably, one or more sensors are electronically coupled to the fan so that the fan power depends on the output data from the sensor or sensors. Preferably, this sensor or these sensors comprise a humidity sensor for the air in the tank and/or the humidity of the grinded organic waste and/or of the potting soil contained in the tank. For example, when the composter according to this embodiment is such that it comprises a sensor for the humidity of the grinded organic waste and/or the potting soil contained in the tank, this sensor is preferably electronically coupled to the fan so that the power of the fan depends on the output data from the sensor. A variation on the power of the fan can be implemented, for example, by varying the voltage of a fan supply between terminals such as 5 and 12V. The fan power preferably depends linearly on the humidity data. For example, the higher the humidity data, the greater the power induced. In addition, and preferably, the fan runs continuously, with only its power varying.

Preferably, when the composter comprises one or more sensors and an aeration system as described above, at least some of the sensors (typically those which measure data about the air circulating in the tank) are arranged at the level of the air outlet and surrounded by a lateral bulkhead adapted to guide the air circulation. The air circulating in the tank is thus directed specifically towards these sensors, thanks to the aeration system and the bulkhead, so that the data from these sensors relates only to the air leaving the tank, in the air circulation, and not to the ambient air outside the tank. In this way, the data obtained via these sensors is all the more precise and their margin of error is reduced. In this case, when the air outlet comprises an air filter, the latter is preferably arranged at the outlet of these sensors.

The air circulating in the aeration system then preferably passes successively through an area in which these sensors are located, surrounded by the lateral bulkhead, an air filter as described above, and then an outlet grid of the air outlet opening onto the outside of the composter.

Two particular preferred embodiments of the aeration system, each compatible with all of the above considerations, are set out below, and are implemented respectively in the preferred embodiments of the composter of the figures introduced below 1A to 4B, on the one hand, and 5A to 10B, on the other. The aeration system is by no means limited to these two embodiments within the scope of the present invention.

In the first of these embodiments, the orifices are fitted in a side wall of the tank, and the air outlet is adjacent to the side wall, arranged at the level of the bottom of the tank.

According to the second of these embodiments, the orifices are made in a lower portion of a (hollow) tube passing through the tank, and the air outlet is adjacent to the air inlet, and preferably arranged at the level of the composter inlet.

The tube preferably extends from the bottom towards the top of the tank, along the axle of the composter. It consists, preferably, and in relation to an embodiment hereinafter introduced, of a mechanical axle mechanically coupled to the first and/or second actuators and driving the grinder and/or the mixer. This particular embodiment allows the tube to be arranged in a simple and practical way, without cluttering up the tank or obstructing the mixer.

In these two embodiments, the orifices preferably extend along the axle of the composter over 10% to 15% of the height of the tank (measured along this axle), for example approximately 10 cm, measured from the bottom of the tank. The side wall or the tube, depending on the embodiment, preferably comprises a mesh coating with a tight mesh at the level of the orifices so that only air (and not the potting soil) can pass through it. In particular, this coating makes it easier to manufacture the composter, as the orifices can be made with simpler tools and be larger. For example, they have a diameter of between 1.5 and 2.5 mm, for example, about 1.9 mm, while the holes in the coating have, for example, a diameter of between 0.1 and 0.25 mm, for example, about 0.18 mm, and a mesh diameter, for example, of about 120 μm.

This first embodiment has the advantage of being simple to plan and of not cluttering up the tank with elements of the aeration system. Preferably, the orifices are provided around the entire circumference of the side wall of the tank, at the level of the bottom of it. The air outlet can then correspond to the assembly of this circumference, and a mesh coating and an air filter can easily be provided to it. Alternatively, the air outlet can without limitation be defined as being specifically at the level of any lateral bulkhead surrounding the sensors.

The second embodiment has the advantage of bringing the more technical elements of the aeration system (and potentially the composter) to the same level, preferably on an upper wall completely surmounting the tank. This makes it easier to maintain these elements and replace them in the event of failure than if they extend throughout the composter. The size of the tank is also easier to adjust. In addition, a single air filter can be arranged in both the air inlet and the air outlet, thus extending its effects to the air inlet, without the need for two air filters, and two related maintenance operations.

In a preferred embodiment of the present invention, the bottom of the tank comprises a removable segment that can be moved to allow the potting soil to be recovered from the tank into a container. The potting soil produced in the composter can be recovered particularly easily via this removable segment. Its movement typically leaves an opening in the bottom of the tank through which the potting soil flows. The outlet typically comprises this removable segment.

There are several ways of recovering the potting soil. For example, the container can be a simple container that a user holds under the removable segment. In this case, the removable segment is preferably mechanically coupled to a handle for moving the removable segment, which can be easily grasped by the user. Preferably, the removable segment is bordered by a gasket to guarantee the hermeticity of the bottom of the tank. The handle and the gasket are preferably part of the outlet.

Alternatively, the container can be a sliding drawer, surmounted and bordered by the bottom of the tank (and therefore lower than the bottom of the tank), which forms an integral part of the composter and makes it easier to use. So when the removable segment is moved, the potting soil falls directly into this drawer. Once the removable segment has been put back in place, so as to reconstitute the bottom of the tank, the drawer can slide out and give access to the recovered potting soil, simply and cleanly. In this case, optionally the bottom of the tank consists of the removable segment, which is preferably sliding and comprises a handle allowing a user to slide it. The drawer should also be part of the outlet.

According to a preferred embodiment of the invention, the composter is equipped with a cartridge comprising:
an upper support segment bearing on an upper wall of the composter and projecting from the tank,
a lower segment containing an insecticide composition, and
an intermediate segment extending from the upper segment to the support segment, and comprising at least one opening sized to allow the passage of insects, for example flies,

the intermediate segment (and optionally also the lower segment) being in fluidic communication with the tank, and preferably arranged in the tank. The term “upper wall” preferably refers to a wall bordering the top of the composter along the axle of the composter, and surmounting the tank.

This type of composter according to this embodiment allows to prevent the undesirable proliferation of flies and other insects, typically drosophila, in the compost. The organic waste introduced into the composter is likely to contain insect eggs or insects, typically drosophila eggs, which find the ideal temperature and humidity conditions in the tank to develop. These insects are not a direct nuisance because they are enclosed in the tank. However, it is preferable to eliminate them, which is possible with the above-mentioned cartridge.

In practice, the cartridge is easily replaced by manipulating the upper segment, which can be lifted manually to remove the cartridge, and can be replaced by bearing on the upper wall of the composter. Alternatively, the cartridge can be attached to the upper wall of the composter and its contents made accessible via a cover. This makes it easy to refill with insecticide composition. As the intermediate segment is in fluidic communication with the tank, insects present in the compost can access the intermediate segment and preferably the lower segment where they are killed by the insecticide composition.

The composition preferably comprises an insect attractant, such as vinegar, and a surface tension suppressant, such as an oil or liquid soap, to cause insects attracted by the smell of vinegar to sink and attempt to drink the insecticide composition. Advantageously, this composition is simple to manufacture and inexpensive, while being perfectly ecological and natural.

According to a preferred general embodiment of the invention, the composter comprises an enclosure surmounting the tank and housing and/or bordering the grinder, the inlet comprising a passage fitted in the enclosure, so that the organic waste received through the inlet enters the enclosure prior to being grinded by the grinder. The enclosure allows to store more organic waste to be grinded, and typically to introduce organic waste without necessarily having to grind them all directly. The enclosure also plays a protective role for the user. In fact, the grinder sheltered and/or bordered by the enclosure could injure the user. The enclosure also plays an aesthetic role as it conceals the grinder and the waste from the user's view, particularly during the organic waste grinding operation. Lastly, it avoids the waste splashes during this operation.

Preferably, mixing means (in other words, a second mixer) are arranged in the enclosure to mix the organic waste contained in the enclosure. These means are preferably located above the grinder. Advantageously, they allow preliminary mixing and aeration of the organic waste to be grinded at the start of composting, typically when the organic waste remains in the enclosure for several days. They also allow the organic waste to be moved from the top towards the bottom of the enclosure, towards the grinder, so that it can be grinded and then moved down into the tank.

The mixing means may, for example, take the form of a rotating paddle comprising one or more extensions transverse to the paddle. In general, they can be implemented in the same way as the mixer, or even form an extension to the mixer connected to the second actuator to operate both the mixer and the mixing means. Alternatively, the mixing means can be mechanically coupled to a third actuator separate from the second actuator, and optionally forming a single mechanical part with the first actuator.

According to a preferred embodiment of the invention, the first and second actuators are formed by a single mechanical part mechanically coupled to a mechanical axle, preferably a rotary one, capable of driving both the grinder and the mixer. The axle of the composter is preferably parallel to the mechanical axle. The mechanical axle preferably passes through the tank from bottom to top, at its center.

This embodiment is advantageous because a single actuator activates both the grinder and the mixer, making the composter easier to use and manufacture. Furthermore, in the case of a rotating mechanical axle mechanically coupled to a manual crank handle, simply turning the crank handle activates the grinder and the mixer, without the need for a great deal of force.

When the composter also comprises an aeration system, as in the second embodiment introduced above, the hollow tube passing through the tank is preferably none other than the mechanical axle, which significantly simplifies the implementation of the invention and reduces the overall dimension of the tank.

Preferably, when the mechanical axle passes at least partially through the tank, at least one foot is attached to the mechanical axle and extends transversely from the mechanical axle to the bottom of the tank, within the tank. Preferably, at least two such feet are provided, arranged symmetrically in the tank. They are able to rotate in the tank when the mechanical axle is rotating. These feet allow the compost (or potting soil) to aerate better at the level of the bottom of the tank. They also allow the compost (or the potting soil) to be handled via the outlet if it is too dense or too compact. In the context of this document, the term “foot” is not to be interpreted as a lower support, as such a foot typically has no function of supporting the mechanical axle on the bottom of the tank as such. The term “foot” is used to refer simply to an “extension to the mechanical axle directed towards the bottom of the tank”. These terms may be interchanged for the purposes of this document.

In one embodiment of the invention, a mechanical structure for wall-attaching the composter is provided on the side wall of the tank. In this case, at least one mechanical stiffening element is preferably provided to mechanically couple (for example, via bearings) the mechanical structure and the mechanical axle, so as to stabilise and increase the stiffness of the composter.

Two practical and preferred embodiments of both the grinder and the mixer of the composter according to the invention are now presented, each embodiment of the one being compatible with an embodiment of the other.

According to a first embodiment of the grinder, it comprises blades arranged on partially superimposed toothed wheels facing the tank. The toothed wheels are preferably enclosed in a casing and coupled to the first actuator via a gear and a mechanical axle to be driven in rotation. The organic waste is grinded by their crushing at the level of the rotating toothed wheels, which allows to reduce its volume and increases the surface area accessible to the micro-organisms used for composting. The orientation of the toothed wheels also drives the waste downwards, towards the tank, making the composter easier to use.

It is possible to rotate the toothed wheels in the opposite orientation (for example, by turning a crank constituting the first actuator in the opposite orientation) to unblock organic waste that is stuck between the toothed wheels.

According to a second, distinct embodiment of the grinder, it comprises a rotating blade surmounting a grid bordering the tank. This grid is adapted to retain overly bulky organic waste, so that it is cut by the blade when it is rotated, preferably by the first actuator. For example, the meshing holes are between 1 cm and 2.5 cm in diameter, preferably 1.5 or 2 cm in diameter, which allows waste such as cores to pass through without damaging the blade. This diameter is designed to ensure that waste that is too large to be composted efficiently is retained by the grid and cut by the blade, without systematically cutting all the organic waste introduced into the composter, which could create agglomerates of small organic waste in the tank and prevent the circulation of oxygen. Advantageously, this second embodiment of the grinder is easy to manufacture and operate, particularly when only the blade needs to be rotated. The grid and the blade preferably extend perpendicular to the axle of the composter. The blade preferably extends along a cross-sectional diameter of the composter.

Preferably, the grinder comprises two such blades, preferably no more and no less. Preferably, each blade is bi-directional, which means that the blade can be rotated in either orientation, making it easier to remove any organic waste that may be stuck in the grinder. Each blade preferably has a rounded cutting end edge, which provides a better shearing effect and therefore a better cutting of the waste in the grinder. This rounded edge also induces a lateral movement (inwards or outwards) of the waste in the grinder, making it easier to stuck it against a wall of the grinder and therefore to cut or grind this waste.

Preferably, the blade of the grinder is enclosed (axially) between the grid and a structure for dividing the organic waste to be grinded, surmounting the blade. The dividing structure preferably takes the form of two or three circular sectors extending perpendicular to the axle of the composter. It allows to divide the mass of organic waste to be grinded and makes the operation easier.

In a first embodiment, the mixer comprises a rigid helical wire extending around a helical axle, dimensioned to be moved in the tank in rotation around the helical axle and/or parallel to the helical axle by means of the second actuator. Preferably, the helical axle corresponds to the axle of the composter, with the helical extending from the bottom towards the top of the tank. This mixer is best used in three movements. First, it is lifted along the helical axle to extract a core of compost from the tank. It is then gently shaken along the helical axle to force the compost from the core back into the tank. The second actuator is preferably manual for these operations, so that, advantageously, a user can feel the weight of the compost initially carried by the mixer reduced as it falls back into the tank, thus knowing when to start the third movement. This involves returning the mixer to its initial position. To do this, the rigid helical wire is rotated into the compost, or in other words, screwed, along the helical axle, to penetrate the compost more easily. The mixer allows to homogenise the grinded organic waste so that the potting soil produced by its composting is of the highest quality.

This first embodiment of the mixer is particularly advantageous because it allows to preserve the layers of organic waste (created as they are introduced into the composter) at different stages of decomposition. This has two major advantages. On the one hand, this allows us to respect the cultures of the micro-organisms that are useful for composting, which vary by layer depending on the stage of decomposition. Furthermore, as the bottom of the tank contains wall compost in the form of potting soil, or at least is designed to contain it, it is advisable not to mix this potting soil with organic waste at an earlier stage of decomposition, so that the potting soil at the outlet is pure. This mixer is ideally suited for this purpose.

The rigid helical wire is preferably made of stainless steel and is preferably extended by a rigid straight wire (or at least attached to such a wire, for example, by means of a deformed turn which itself extends the rigid helical wire) of the same material extending parallel to the helical axle partly in the tank, in order to allow the rigid helical wire to move in the tank along the helical axle. These wires preferably have a smooth, regular cross-section, so as not to cut and/or grind the organic waste in the tank, but simply to aerate and mix it, layer by layer, for the reasons set out above. This cross-section is preferably essentially constant and/or circular.

The geometric parameters of these mechanical elements are discussed below in relation to FIG. 3. When the composter comprises the second embodiment of the aeration system introduced above, the rigid wire extending along the helical axle may be substituted for a segment of the hollow tube passing through the tank and extending into the heart of the helical. The hollow tube can also be used as a mechanical axle as described above.

In a second, distinct embodiment, the mixer comprises (at least) one (rotating) paddle. This paddle is preferably carried by a rotating mechanical axle passing through the tank, and extends orthogonally to it. The mechanical axle preferably extends along the axle of the composter, so that it is directed from the outlet towards the inlet. Preferably, the mechanical axle drives the paddle via the second actuator. Preferably, the mechanical axle corresponds to that of one of the embodiments introduced above, as illustrated with reference to FIGS. 5A to 9 introduced below. This mechanical axle can therefore form the hollow tube of the second embodiment of the aeration system mentioned above when the composter comprises one. The term “mechanical axle” used in the formulation of this second embodiment of the mixer is not, however, limited to these particular embodiments set out above. The paddle preferably extends on either side of the tank, so that it passes through it.

This second embodiment is simple to manufacture and industrialise. It's also easy to operate, as all you have to do is turn the paddle using the second actuator. The weight of compost to be moved by the mixer is low, as it corresponds to a layer of compost at the level of the paddle. This makes it particularly easy for a user to set the mixer in motion by means of a second manual actuator, without having to exert a great deal of force on this second actuator.

As the paddle is arranged orthogonally to the mechanical axle directed from bottom to top, its rotation will set a layer of the compost in motion without breaking the layer structure of the compost, which is advantageous for the same reasons as discussed above with regard to the other embodiment of the mixer. In addition, the rotating movement of the paddle frees up space for an air circulation in a corresponding layer of compost, so that the compost is homogenised and aerated. This allows to produce a good quality potting soil.

Preferably, the mixer in this second embodiment comprises at least two such paddles. Each paddle is preferably positioned in the half or two thirds of the tank closest to the inlet, so as to reduce the risk of mixing the wall compost in the form of potting soil with other organic waste at a less advanced stage of decomposition. Advantageously, one or more feet can be attached to the mechanical axle and extend transversely from the mechanical axle to the bottom of the tank, in the tank, in order to allow a specific aeration of this potting soil, as described above with regard to another embodiment of the invention.

Preferably, the paddle is equipped with one or more transverse extensions. These extensions can take the form of smaller paddles, between approximately 10and 40%, for example, between 10 and 20%, of the length of the paddle. In this case, the “length” is preferably the largest spatial dimension of the paddle and extensions. Advantageously, the extensions increase the contact surface of the mixer with the organic waste in the tank. The size of these extensions is such that they are small enough not to break up the layers of the composting as discussed above, and large enough to achieve an adequate homogenisation and aeration of the organic waste. In addition, it is advantageous to limit the size of the extensions in order to limit the energy required by the second actuator to drive the mixer.

Preferably, each end of the paddle comprises such an extension. This allows to increase the contact surface of the paddle with the compost at the edge of the tank, further improving the aeration of it. More precisely, preferably, the extension extends from a free end of the paddle and is oriented from the outlet towards the inlet from the paddle in a plane secant to the paddle forming a smaller angle therewith of between 90° and 160°, preferably between 130° and 160°, for example, approximately 145°. In other words, the extension is oriented from bottom to top according to the above-mentioned inclination. A mixer equipped with these paddles is particularly easy to manufacture and allows the waste in the tank to be mixed around the mechanical axle, giving it a vertical, “upward” incidence, so that it is adequately aerated, in particular in synergy with the advantageous aeration system used. As mentioned above, there is no need for large extensions. For example, their projected length on the mechanical axle is between 1.0 and 2.5 cm, for example 1.5 cm, which limits the resistance of the waste on the extensions, and the energy to be deployed to set the mixer in motion, in particular when said smaller angle is between 130° and 160°.

In one embodiment, the paddles extend from the mechanical axle towards a free end substantially perpendicular to the mechanical axle. They are arranged in sequence along the mechanical axle, and are offset from each other in the sequence by the same angle. Preferably, the number of paddles corresponds to the upper integer of the quotient of 360° by this angle. For example, this number is 4 if the angle is 90°. Advantageously, this “staircase” embodiment of the mixer is easy to implement and offers a very good ratio between the effort required to set the mixer in motion and the mixing effect achieved by preserving the layers.

Each of the present considerations concerning the second embodiment of the mixer extend directly to the mixing means being introduced above when the composter comprises them. These are preferably of the same shape and are driven by the same mechanical axle as the mixer.

### BRIEF DESCRIPTION OF THE FIGURES

Further characteristics and advantages of the present invention will become apparent from the following detailed description, for the understanding of which reference is made to the attached figures, among which:

FIGS. 1A and 1B illustrate overall external side views of the top of a composter according to a first embodiment of the invention;

FIGS. 2A, 2B and 2C show top, superimposed and overall sectional views of a grinder of the composter illustrated in FIGS. 1A and 1B;

FIG. 3 shows a side view of a mixer of the composter illustrated in FIGS. 1A and 1B and the mechanical parts with which it is associated and coupled;

FIGS. 4A and 4B illustrate external views of an outlet of the composter illustrated in FIGS. 1A and 1B, comprising a removable bottom of a tank and a drawer for recovering potting soil;

FIGS. 5A and 5B illustrate overall external views, firstly of the side and top, and secondly of the side and bottom, of a composter according to a second embodiment of the invention;

FIGS. 6A and 6B illustrate internal side views, with and without a wall of an enclosure, of the composter illustrated in FIGS. 5A and 5B;

FIG. 7 shows an interior view of a grinder of the composter illustrated in FIGS. 5A and 5B, and its surroundings;

FIG. 8 shows an interior side and bottom view of the composter illustrated in FIGS. 5A and 5B;

FIG. 9 illustrates an overall side view of a mixer for the composter according to the second embodiment described above;

FIGS. 10A and 10B show two side views of the top of a paddle of the mixer shown in FIG. 9.

The drawings in the figures are not to scale. Similar elements are generally denoted by similar references in the figures. In the scope of this document, the same or similar elements may have the same references. For example, the rigid helical wire of said first embodiment bears the same reference as the rotating paddles of said second embodiment, since they are portions of the respective mixers of the composters of these embodiments that perform the same function, even though these portions are structurally different.

In addition, the presence of reference numbers or letters in the drawings is not to be regarded as limiting, even when these numbers or letters are indicated in the claims.

### DETAILED DESCRIPTION OF EMBODIMENTS OF THE INVENTION

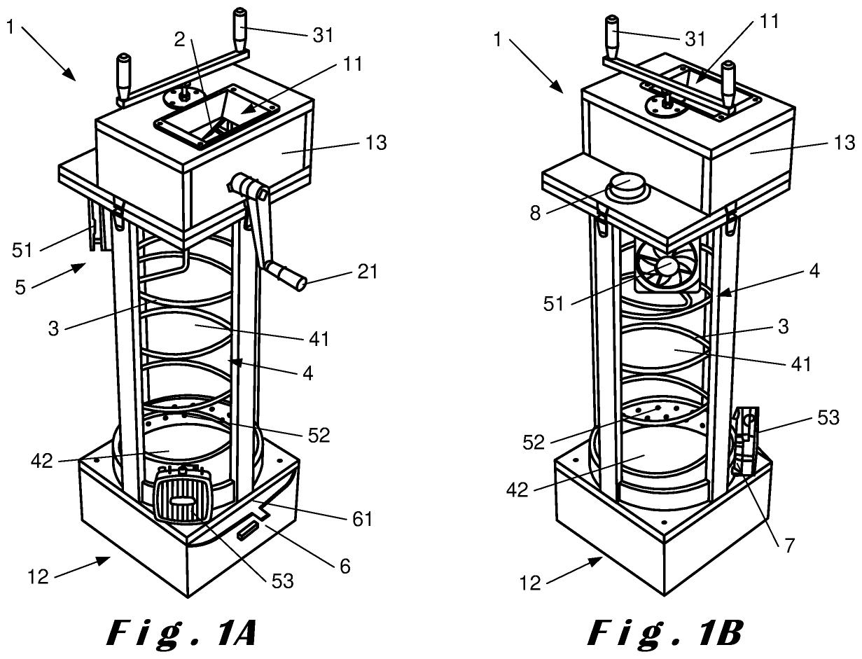

This section presents a description of two preferred embodiments of the invention on the basis of particular embodiments and numerical references to FIGS. 1A to 10B without being limited by them. In particular, the drawings in the figures described below are only schematic and are not limiting.

A first embodiment of the composter 1 according to the invention is described with reference to FIGS. 1A to 4B. A second embodiment of the composter 1 according to the invention is described with reference to FIGS. 5A to 10B. The inlet 11, the outlet 12, the grinder 2, the mixer 3 and the aeration system, for example, are at least partly separate according to these two embodiments. As will be obvious from the description of the invention to the person skilled in the art, in general, the specific embodiments of these technical elements of the composter 1 are completely interchangeable between these two embodiments.

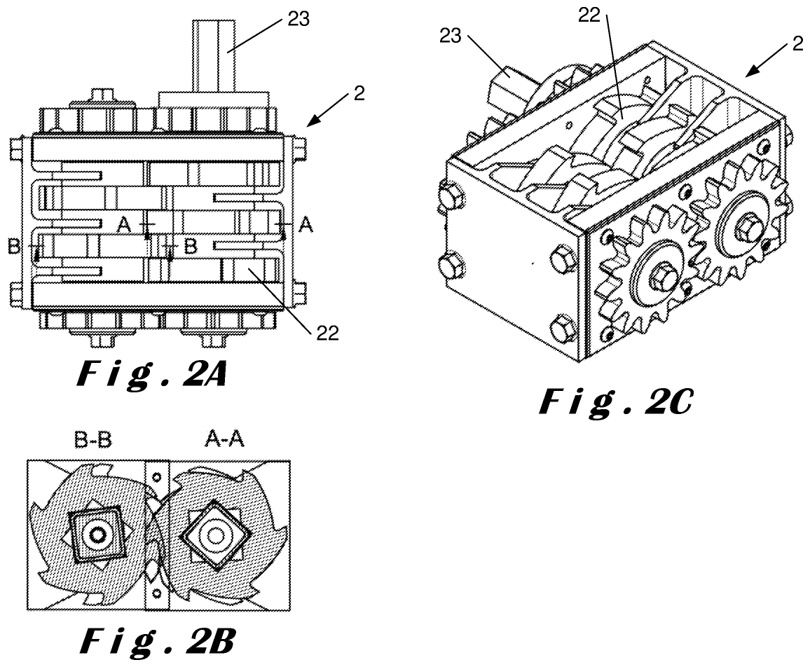

The first embodiment is shown in FIGS. 1A to 1B. The composter 1 comprises an enclosure 13 in which is fitted a passage defining an inlet 11 through which organic waste can be introduced. The passage can be conical and/or adapted to accommodate a funnel. A cover (not shown) can be arranged in the passage to cover it, for aesthetic and hygienic reasons. The enclosure 13 houses a grinder 2 shown in FIG. 2 and coupled to a first actuator 21. The first actuator 21 takes the form of a turning crank, which is fitted laterally to the enclosure 13.

FIGS. 2A, 2B and 2C show the grinder 2 in more detail. It comprises five toothed wheels 22 carrying blades in the form of pointed ends of the toothed wheels 22. The number of toothed wheels 22 is of course not limited to five. They are assembled in a casing and mechanically coupled to said first actuator 21 via a mechanism 23 which can be implemented in various known ways (for example, via a gear and/or an axle). The toothed wheels 22 partially overlap as shown in FIG. 2B. The first actuator 21 is then used to drive them in rotation in opposite directions in pairs, so that the organic waste is grinded, cut up and driven downwards into a composting tank 4, as shown in FIGS. 1A and 1B. The size of the toothed wheels 22 is such that the organic waste is cut to a thickness of approximately 1.5 cm. This figure is a compromise between the need to cut organic waste that is too large to be composted efficiently, and the fact of not having organic waste in the tank that is too small, which would create agglomerates and prevent the circulation of oxygen in the tank 4.

As can be seen in FIGS. 1A and 1B, the tank 4 is cylindrical. For example, it has a diameter of 30 cm, an axial height of 90 cm and a compost volume of around 50 litres. The shape, the dimensions and the capacity of the tank can be adjusted to suit domestic needs, without affecting the operation of the composter in any way. This information can also be applied to the second embodiment of the composter described below. The tank 4 in the context of the present invention is nevertheless preferably cylindrical in general so as to present a smooth and symmetrical shape around an axle facilitating both the design of the tank and the arrangement of technical elements within it, and offering a smooth side wall 41 to the compost in the tank 4, which allows it to slide progressively down the tank 4, without creating amalgams in any angular points thereof. In FIGS. 1A and 1B, the tank is shown as transparent, making it easier for a user to see the compost inside.

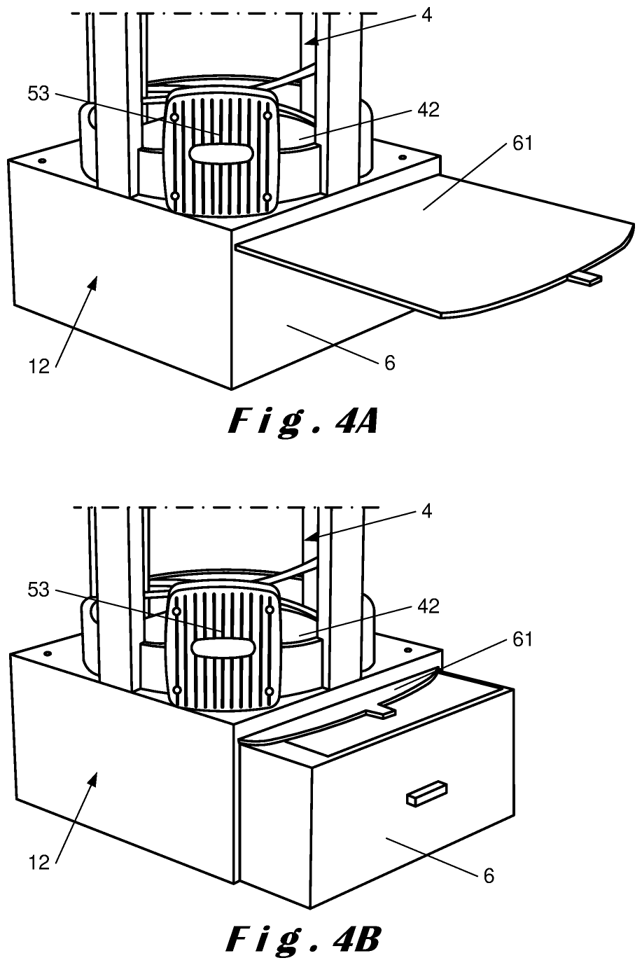

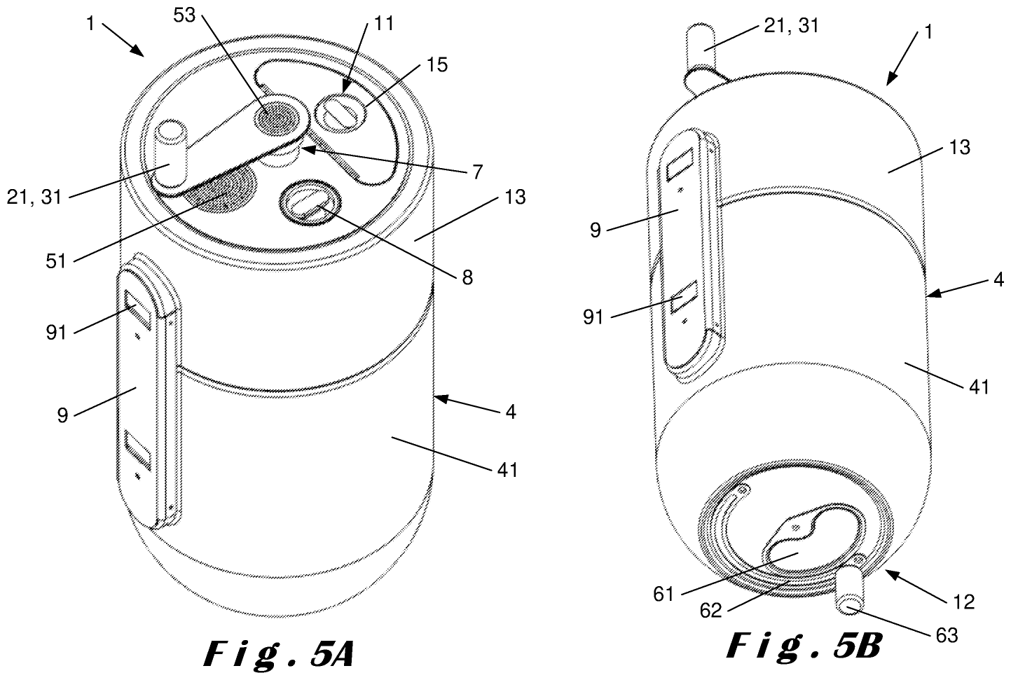

The grinded organic waste thus falls by gravity into the tank 4. The mature compost will form potting soil at the level of the bottom 42 of the tank 4, as this is where the oldest grinded organic waste is, and therefore at a more advanced stage of composting. As can be seen in FIGS. 4A and 4B, the bottom 42 of the tank 4 consists of a removable plate 61 equipped with a handle that can be slid. This removable plate 61 surmounts a container 6 consisting of a sliding drawer for recovering the potting soil. In this way, a user can easily and cleanly recover potting soil produced in the tank 4 by pulling the removable plate 61 to let drop the potting soil into the drawer, replacing the removable plate 61 to prevent the column of organic waste in the tank 4 from collapsing or escaping, and then opening the drawer to access the potting soil. For example, the drawer can be completely detached from the bottom of tank 4 to allow the potting soil to be moved easily before use. These technical means define an outlet 12 of the composter 1.

To allow to homogenise and aerate the grinded organic waste in the tank 4, a mixer 3 is arranged within it. It is mechanically coupled to a second actuator 31 in the form of a crank with double handles, to make it easier to handle the mixer 3 and any weight it may be carrying.

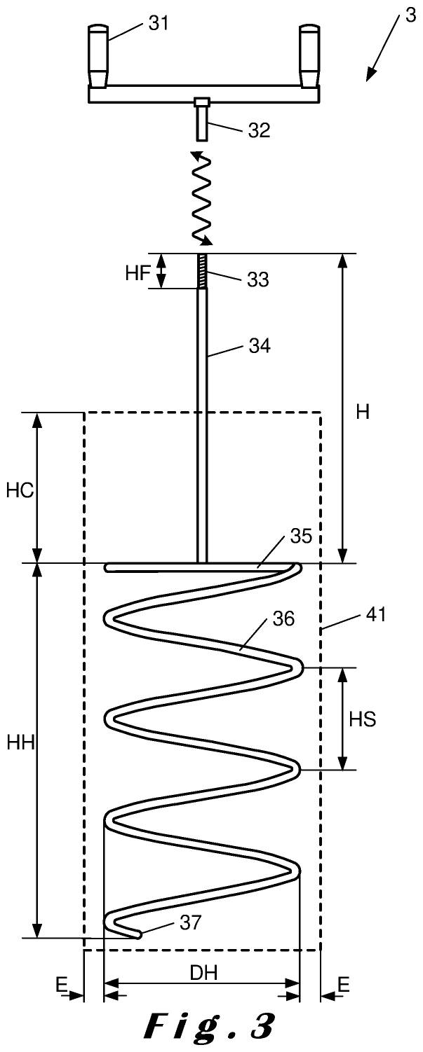

The mixer 3 is described in detail in FIG. 3. It comprises a rigid helical wire 36 made of stainless steel, the helical axle of which corresponds to an axis of revolution of the tank 4, defining an axle of the composter 1. The mixer 3 has a smaller diameter (or width) DH than that of the tank 4, symmetrically defining a space E between the mixer 3 and the side wall 41 of the tank 4. The diameter of the tank 4 is determined to have an acceptable height and a fairly large total volume, while the space E is determined to limit the quantity of organic waste that is not mixed (and avoid the formation of amalgams on the side wall 41), without inducing friction between the mixer 3 and the side wall 41 via the organic waste, as such friction would require the mixer to be handled with greater force. In addition, the diameter DH as such is chosen so as not to excessively increase the weight of the mixer, while still mixing a sufficient quantity of organic waste.

The rigid helical wire 36 defines, for example, from 3 to 6 turns, each having a constant turn height HS large enough not to induce too great a weight on the mixer or on the organic waste captured by these turns, but also small enough to limit the elastic spring effect of the rigid helical wire 36, so that the weight of the organic waste does not deform it when the mixer 3 is in action, the mixer 3 having to remain rigid. An upper end (top) of the rigid helical wire 36 terminates in a deformed turn 35 extending perpendicular to the helical axle, in order to stiffen the mechanical coupling to the second actuator 31. The other (lower) end 37 of the rigid helical wire 36 is preferably round and smooth. More generally, the rigid helical wire 36 and the deformed turn 35 are preferably made of a smooth round wire, the cross-sectional diameter of which is chosen to be large enough to induce sufficient stiffness to the mixer 3 to prevent it from deforming when it is in operation, without being too large in order to limit the weight of the mixer 3.

The rigid helical wire 36 does not extend throughout the tank 4, but over an axial height (i.e. along the helical axle) HH. The deformed turn 35 is extended by a straight rigid wire 34 of the same material extending along the helical axle partly into the tank 4, in order to allow the helical rigid wire 36 to move in the tank 4 along the helical axle. The portion of the straight rigid wire 34 extending into the tank 4 (when the mixer is at rest) is of height HC. It is precisely from this height that the rigid helical wire 36 can move parallel to the helical axle in the tank 4. The height HC therefore defines the stroke of the mixer 3. This is typically 50 to 70% of the diameter of the tank 4, to allow a sufficient mixing and an aeration of the compost in each layer. The overall height H of the rigid rectilinear wire 34 is chosen so that it can pass through the enclosure 13 and arranged the second actuator 31 at its end, for example, by screwing a threaded segment 33 of the rigid rectilinear wire 34 of a height HF into a threaded female rod 32 of the second actuator 31.

For a tank 4 with a diameter of 30 cm, the purely exemplary and totally non-limiting values of the above-mentioned parameters are given: HC=17 cm, or generally between 15 and 20 cm; HH=50 cm; HS=13.5 cm; DH=22 cm, or generally between 20 and 25 cm; E=4 cm, or generally between 2.5 and 5 cm; number of turns=3.7, or generally between 3 and 6; section diameter of the rigid helical wire 36=1 cm; mixer weight<3 kg. A person skilled in the art will understand that these numerical data are to be adapted in proportion (%) with respect to the diameter of the tank 4, for other diameters of the tank 4, for example, 25 cm, 35 cm, 40 cm, 45 cm, with the exception of the space E which can either be constant or be adapted in proportion. The HF and H values are less dependent on the size of the tank 4, and more on the size of the enclosure 13. Non-limiting examples of numerical values are given by HF=4.7 cm and H=41.3 cm.

A cartridge 8 containing an insecticide composition can be arranged above the tank 4, as shown in FIG. 1B and as described in the description of the invention.

As illustrated in FIGS. 1A and 1B, the composter 1 is also provided with an aeration system 5 comprising a fan 51 arranged in an air inlet in the side wall 41 of the tank, at the top of the tank, so that it at least partly surmounts the tank. The fan 51 allows to draw outside ambient air into the tank 4 and oxygenates the compost to speed up composting. Once the air has entered the tank 4, it can leave through air circulation orifices 52 pierced in a circumference of the side wall 41 of the tank 4, at the bottom of the tank 4, at the level of the bottom 42 of it. The air thus passes through the entire tank 4, from top to bottom, before leaving it. A specific air outlet 53 can be arranged on the side wall 41 and coupled in a fluidic manner to some of the orifices 52 shown in FIGS. 1A and 1B. The air outlet 53 comprises a lateral bulkhead adapted to guide the circulation of air specifically out of the tank, and enclosing parameter sensors 7 for assessing composting conditions in the tank 4. In this way, the sensors 7 are specifically arranged at the air outlet 53 to capture only air leaving the tank 4, so that the measurement of the sensors 7 is not disturbed by the external ambient air. The air outlet 53 comprises an air filter as explained in the description of the invention. The air filter is then preferably arranged at the outlet of the sensors 7.

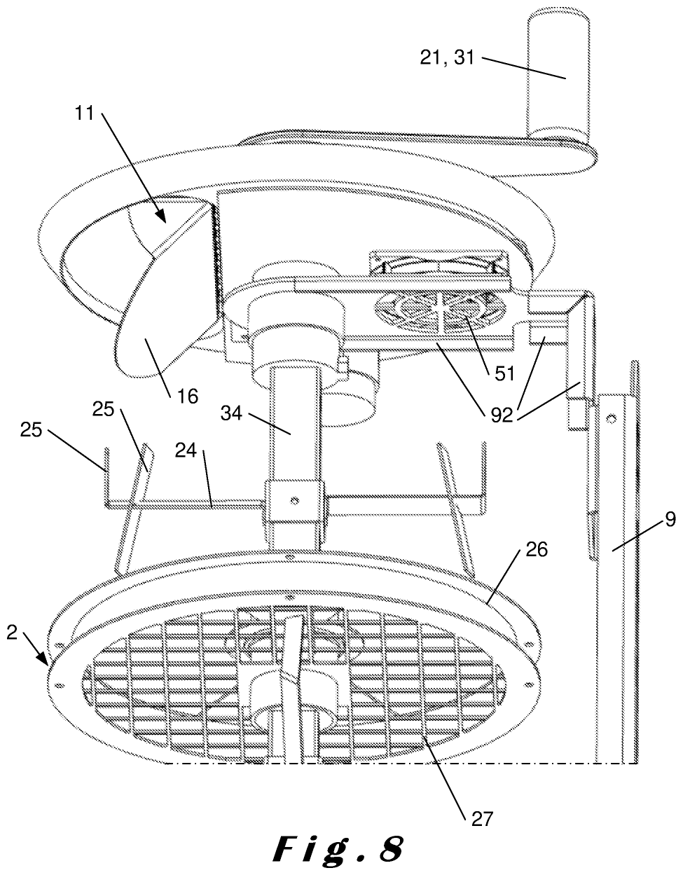

The second embodiment is shown in FIGS. 5A to 10B. The composter 1 comprises an enclosure 13 in which is fitted a passage defining an inlet 11 through which organic waste can be introduced. For aesthetic and hygienic reasons, a cover 15 is placed in the passage to cover it. As can be seen in FIG. 8, the inlet 11 surmounts a deflector 16 facing away from a cartridge 8 (visible in FIGS. 5A, 6B and 8) containing an insecticide composition as introduced in the first embodiment. The purpose of the deflector 16 is to prevent flies attracted by the cartridge 8 from passing through the inlet 11 to leave the composter 1. It plays an aesthetic and safety role by concealing the mechanical elements and organic waste in the enclosure 13 from the user's view.

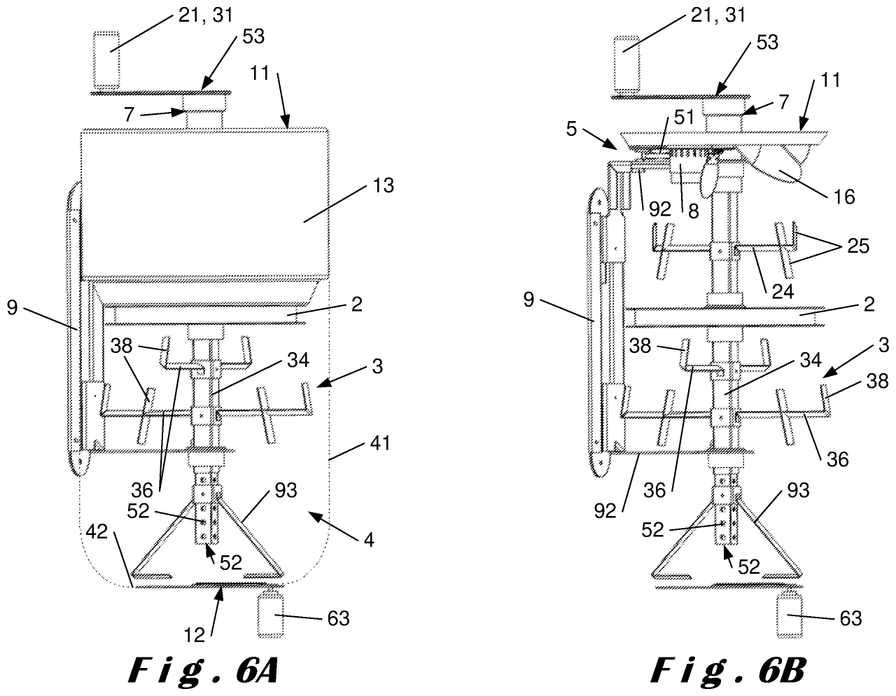

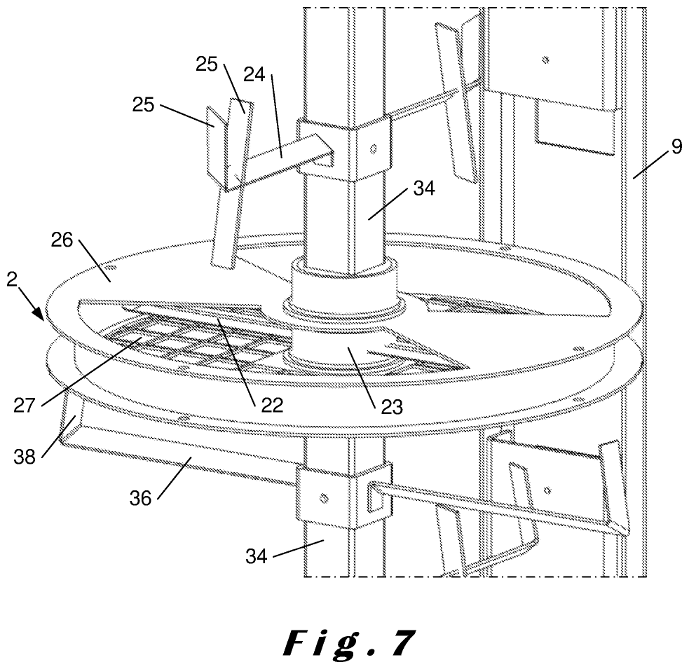

The enclosure partially houses and surrounds a grinder 2 visible in FIG. 7. Once grinded, the organic waste is driven downwards into a composting tank 4, as shown in FIGS. 5A to 6B. One difference with the first embodiment is that the enclosure houses mixing means 24, 25, similar to a mixer 3 arranged in the tank for mixing the organic waste. Another difference is that a hollow rotary mechanical axle 34 passes through the enclosure 13 and the tank 4, from the level of the inlet 11 (at the top), to the level of a bottom 42 of the tank 4 (at the bottom), without touching this bottom 42, and that this mechanical axle 34 drives in rotation the grinder 2, the mixing means 24, 25 and the mixer 3, via a single manual actuator 21, 31 (corresponding to the previous first and second actuators) in the form of a crank to be turned by a user. This actuator 21, 31 is arranged on an upper wall of the composter, at the same level as the inlet 11, for ease of use.

The enclosure 13 comprises a wall having a conical lower segment extending from a side edge of the grinder 2 as shown in FIG. 6A, so as to completely separate the space of the enclosure 13 from that of the tank 4 hereafter introduced, the latter being bordered by the grinder 2.

FIGS. 6B, 7 and 8 show in more detail the grinder 2 and the interior of the enclosure 13. The mixing means 24, 25 are preferably similar to the mixer 3 and comprise a paddle 24 extending along a diameter of the enclosure 13, but keeping a distance similar to E separating it from the wall of the enclosure 13. The paddle 24 comprises transverse extensions 25 to improve the aeration of the organic waste in the enclosure 13. The purpose of these mixing means (24, 25) is also to force the waste down through the grinder 2 into the tank 4 by gravity.

As can be seen in FIG. 7, the grinder 2 comprises a rotating blade 22 extending perpendicularly to the mechanical axle 34 and coupled thereto via a mechanism 23 which can be realised in various known ways (for example, via an eyelet). The blade 22 is axially enclosed between, above, two circular sectors 26 of a circular plate perpendicular to the mechanical axle 34 constituting a waste division structure, and below, a grid 27 bordering the tank 4 and being perpendicular to the mechanical axle 24. A grid 27 with holes 1.5 to 2 cm in diameter is suitable for calibrating the size of the organic waste in the tank 4 as detailed in the description of the invention. Although the two sectors 26 are shown as flat, almost without thickness, in FIGS. 6A to 8, an embodiment in which they were much thicker, for example 1.0 to 2.0 cm, in a direction corresponding to the mechanical axle 34, for reasons of strength and resistance, would not depart from the scope of the invention. Preferably, although not shown in FIG. 7, the blade 22 is bi-directional and has a rounded end edge to increase the shearing effect of the cut.

The tank 4 is mainly cylindrical, but its bottom 42 is partially spherical, or more precisely it has the shape of a crushed sphere, giving it a particularly aesthetic and practical design to handle. For example, it has a diameter of 30 cm. The total axial height of the composter 1 is around 90 cm, with a compost volume of around 50 litres. The shape, the dimensions and the capacity of the tank can be adjusted to suit the domestic needs, without affecting the operation of the composter 1 in any way. The case of a cylindrical or partially cylindrical tank 4, in all cases with a smooth side wall 41 and a bottom 42, is preferred for the same reasons as set out in relation to the first embodiment, this applying generally within the framework of the invention.

The grinded organic waste thus falls by gravity through the grid 27 into the tank 4. The mature compost will form potting soil at the bottom 42 of the tank 4, as this is where the oldest grinded organic waste is, and therefore at a more advanced stage of composting. As can be seen in FIGS. 5B and 6A, the bottom 42 of the tank 4 comprises a removable segment 61 which can be moved by means of a handle 63. A gasket 62 provides the sealing at the level of the bottom 42 of the tank 4 opposite the removable segment 61. Once the removable segment 61 has been moved, simply collect the potting soil in a manual container and replace the removable segment 61. These technical means define an outlet 12 of the composter 1.

To allow to homogenise and aerate the grinded organic waste in the tank 4, a mixer 3 is arranged within it. As can be seen in FIGS. 6A and 6B, it comprises two rotating paddles 36 carried by the mechanical axle 34 and extending perpendicularly thereto, as far as opposite sides of the side wall 41 of the tank 4, while leaving a space between the paddles and the side wall 41, comparable in terms of use and size to the space E introduced for the first embodiment. The paddles 36 are located in the upper (top) half of the tank 4 so as not to affect the potting soil at the bottom 42 of the tank 4. They comprise transverse extensions 38 oriented to efficiently aerate and mix the compost in layers as described in the description of the invention.

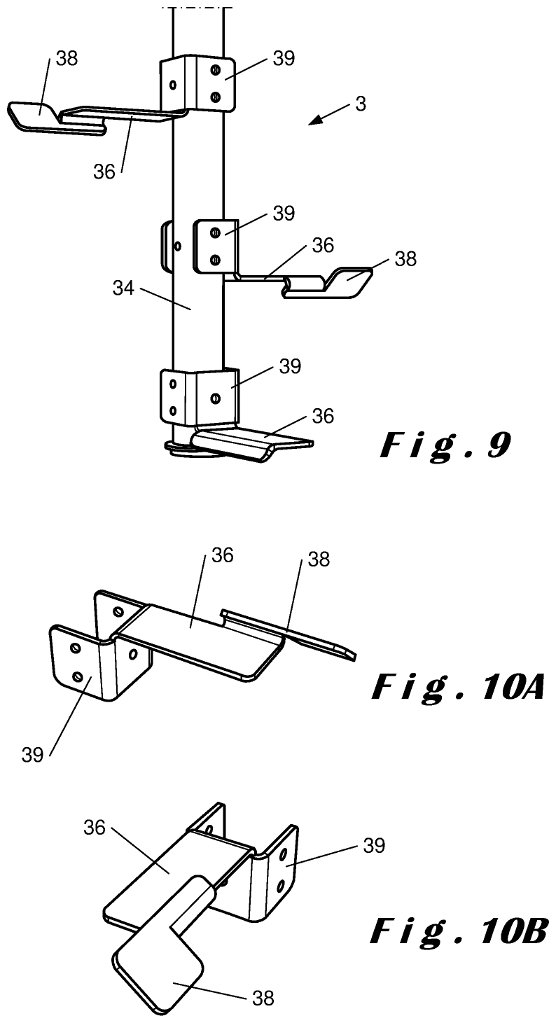

FIG. 9 illustrates an alternative mixer to that shown in FIGS. 6A to 7 for the composter 1 according to the second embodiment. As in the previous embodiment of the mixer 3, a plurality of paddles 36 extend from the mechanical axle 34, some paddles 36 comprising an extension 38 at their free end (that opposite to that attached to the mechanical axle 34). In this embodiment, the paddles 36 do not extend on either side of the mechanical axle 34, but only on one side. Preferably, four paddles 36 are provided on the mechanical axle 34 in the tank 4. Each paddle 36 is offset by 90° with respect to the other, the paddles 36 thus being arranged in a rotating staircase as seen in FIG. 9 where three paddles are shown. The paddle 36 closest to the bottom 42 may or may not have an extension at its free end; in FIG. 9, it has no extension to limit the movement within the more maturated compost.

The paddles 36 of the mixer 3 shown in FIG. 9 can also be seen separately in FIGS. 10A and 10B. Each paddle 36 shown in FIG. 9 comprises a segment 39 adapted to at least partly conform to the shape of the mechanical axle 34 so as to be firmly and resiliently attached thereto. A main portion of the paddle 36 is essentially flat and extends from the segment 39 perpendicular to the mechanical axle 34. The extension 38 of the paddle 36 is arranged from a folded rim of the main portion and extends in a plane intersecting that of the paddle 36, forming a smaller angle of approximately 145° between them. The way in which the extension 38 is formed from its folded rim, and the thickness of the paddle 36 (i.e. preferably from 2.0 to 5.0 mm) make it particularly resistant to the forces exerted on it. The extension 38 is oriented to lift waste upwards and ensure a good aeration, as described in the description of the invention. The extensions 38 extend relatively little upwards (and are, for example, about 1.5 to 2.0 cm high when projected onto the mechanical axle 34), so as not to cause the compost and waste to mix too much either, and therefore to maintain layer-by-layer composting. This limited height also allows to reduce the effort required to operate the mixer 3.

The paddles 24, 36 and their extensions 25, 38, as illustrated in FIGS. 6A to 10B are preferentially representative of their exact positioning, their geometry and their orientation, so that such characteristics implicit in the view of these figures are fully part of the invention.

In order more specifically to aerate the potting soil at the bottom 42 of the tank, but also to handle it if necessary via the outlet 12, feet 93 attached to the mechanical axle 34 and extending transversely from the latter to the bottom 42 of the tank 4 may be provided. For example, two such feet 93 directed and oriented in the opposite direction to the mechanical axle 34 are provided, together having a partial triangular shape resting on the bottom 42. However, the feet 93 do not touch the bottom 42 for obvious reasons, in particular to ensure that the rotation of the mechanical axle 34 does not require too much effort and that no friction is generated between the portions of the composter 1, which would reduce the service life of the composter 1. The same reasons apply to justify a space E between the paddles 24, 36 (and/or the extensions 25, 38) and the side wall 41 of the tank 4. Alternatively, the mechanical axle 34 may be based below the level of the bottom 42 of the tank 4, without such feet 93 being present, and without the mechanical axle 34 being in contact or in friction with the bottom 42.

The composter 1 is provided with an aeration system 5, as shown in FIGS. 5A, 6B and 8. This aeration system 5 comprises a fan 51 arranged in an air inlet in the upper wall of the composter 1, at the top of the enclosure 13, so that it surmounts the enclosure 13 and the tank 4. The purpose of the fan 51 is to draw outside ambient air into the tank 4, and to oxygenate the compost in the enclosure 13 and in the tank 4 so as to speed up composting. Once the air has entered the tank 4, it can exit through air circulation orifices 52 pierced at the bottom of the mechanical axle 34, as well as through the open end of the mechanical axle 34, this end also constituting such an orifice 52. The orifices 52 are arranged at the level of the bottom 42 of the tank 4. The air thus passes through the entire tank 4, from top to bottom, before leaving it via the hollow mechanical axle 34. The air then travels up the mechanical axle 34 to an air outlet 53 fitted in the upper wall of the composter 1 (or, as shown, in the crank handle to make the composter 1 more compact). This air outlet comprises an air filter and is preceded by sensors 7 arranged in the mechanical axle 34. Advantageously, compared with the first embodiment, the lateral bulkhead which encloses the sensors 7 and guides the air circulation out of the tank is none other than the mechanical axle 34 itself, or rather its upper end (top). This has major advantages in terms of the design of the composter 1, because the fan 51, the sensors 7, the air filter and the cartridge 8 are all arranged on the upper wall of the composter 1, and because it is not necessary to provide a lateral bulkhead for the sensors 7. The industrialisation of these technical parts, their replacement and their repair are thus facilitated, while the dimensions of the enclosure 13 and of the tank 4 can also be adapted, for example, in height, to a larger composting volume without replacing all of these technical parts.

The composter 1 according to the present invention can be placed on a support or hung on a wall. The second embodiment shows a mechanical structure 9 for attaching the composter 1 to the wall, arranged straddling the side wall 41 of the tank 4 and that of the enclosure 13. This mechanical structure 9 comprises anchoring points 91 for the composter 1 as shown in FIGS. 5A and 5B. As can be seen in FIGS. 6B and 8, two mechanical stiffness arms mechanically couple the mechanical structure 9 and the mechanical axle 34, so as to stabilise and increase the stiffness of the composter 1.

In summary, the invention relates to a domestic composter 1 for organic waste equipped with an aeration system 5 and a grinder 2 surmounting a tank 4 in which a mixer 3 is arranged. The invention has been described herein in relation to specific embodiments, which are purely illustrative and in no way intended to be limiting. The numerical values given for information purposes in this document are given with a margin of error of 5%. Generally speaking, it will be apparent to a person skilled in the art that the present invention is not limited to the examples illustrated and/or described above, and that its scope is defined by the claims hereinafter introduced.

1. A domestic organic waste composter, comprising:
an inlet for receiving organic waste;
a grinder for grinding the organic waste, the grinder coupled to a first actuator;
a tank surmounted by the grinder and arranged to contain the organic waste ground by the grinder;
a mixer arranged in the tank and configured to mix the ground organic waste contained in the tank, coupled to a second actuator;
an outlet arranged at the level of a bottom of the tank and configured to recover a potting soil produced by composting the organic waste contained in the tank;
an aeration system, including:
an air inlet at least partially surmounting the tank and containing a fan;
orifices for circulating air in the tank at the level of the bottom of the tank; and
an air outlet fluidly coupled to the orifices; and
the aeration system configured to generate a circulation of air in the tank from the air inlet towards the air outlet via the orifices.

2. The composter according to claim 1, wherein the first and second actuators are manual.

3. The composter according to claim 1, further comprising a set of one or more sensors, including:
a temperature and/or humidity sensor for the air in the tank;
a temperature and/or humidity sensor for the ground organic waste and/or the potting soil contained in the tank; and/or
a sensor for a selection of composting gases in the tank,
wherein the set of one or more sensors is configured to transmit data to a data processing logic unit.

4. The composter according to claim 3, wherein at least some of the set of one or more sensors are arranged at the level of the air outlet and surrounded by a lateral bulkhead adapted to guide the air circulation.

5. The composter according to claim 3, wherein the set of one or more sensors includes a sensor for the humidity of the ground organic waste and/or the potting soil contained in the tank, the humidity sensor being electronically coupled to the fan such that a power of the fan depends on an output data of the humidity sensor.

6. The composter according to claim 1, wherein the orifices are fitted in a side wall of the tank, and wherein the air outlet is adjacent to the side wall and arranged at the level of the bottom of the tank.

7. The composter according to claim 1, wherein the orifices are fitted in a lower portion of a tube passing through the tank, and wherein the air outlet is adjacent to the air inlet.

8. The composter according to claim 1, wherein the bottom of the tank includes a removable segment that is movable to allow the potting soil to be recovered from the tank into a container.

9. The composter according to claim 8, further comprising a sliding drawer surmounted and bordered by the bottom of the tank, the sliding drawer including the container.

10. The composter according to claim 1, further comprising:
a cartridge having an upper support segment bearing on an upper wall of the composter and projecting out of the tank; a lower segment containing an insecticide composition; and
an intermediate segment extending from the upper segment to the support segment, the intermediate segment being fluidly coupled to the tank and having at least one opening dimensioned to allow the passage of insects.

11. The composter according to claim 1, further comprising an enclosure surmounting the tank and housing and/or bordering the grinder, the inlet having a passage fitted in the enclosure so that the organic waste received via the inlet enters the enclosure prior to being ground by the grinder.

12. The composter according to claim 11, further comprising mixing means arranged in the enclosure surmounting the grinder, the mixing means configured to mix the organic waste contained in the enclosure.

13. The composter according to claim 1, wherein the first and second actuators are formed by a single mechanical part operably coupled to a mechanical axle capable of driving both the grinder and the mixer.

14. The composter according to claim 1, wherein the grinder comprises a plurality of blades arranged on partially superimposed toothed wheels and oriented towards the tank.

15. The composter according to claim 1, wherein the grinder comprises a rotating blade surmounting a grid bordering the tank.

16. The composter according to claim 1, wherein the mixer comprises a rigid helical wire extending about a helical axle and dimensioned to be moved in the tank in rotation about the helical axle and/or parallel to the helical axle by the second actuator.

17. The composter according to claim 1, wherein the mixer comprises a paddle carried by a rotating mechanical axle passing at least partially through the tank and directed from the outlet towards the inlet, the paddle extending orthogonally thereto.

18. The composter according to claim 17, wherein the paddle is equipped with at least one extension arranged transverse thereto.

19. The composter according to claim 18, wherein the extension extends a free end of the paddle and is oriented from the outlet towards the inlet from the paddle in a plane secant to the paddle forming a smallest angle therewith of between 130° and 160°.

20. A method of using a composter according to claim 1 to produce a potting soil by composting organic waste.
